(19) United States
(12) Patent Application Publication
(10) Pub. No.: US 2005/0057446 A1
(43) Pub. Date: Mar. 17, 2005

(54) Plasma display panel and driving method thereof

(76) Inventor: Hak-Ki Choi, Suwon-si (KR)

Correspondence Address: MCGUIREWOODS, LLP, 1750 TYSONS BLVD, SUITE 1800, MCLEAN, VA, 22102, US

(21) Appl. No.: 10/926,291

(22) Filed: Aug. 26, 2004

(30) Foreign Application Priority Data
Aug. 27, 2003 (KR) 2003-0059693

(51) Int. Cl. G09G 3/28

(52) U.S. Cl. 345/60

(57) ABSTRACT

The present invention is directed to an improved plasma display panel. In one embodiment, a method for using the plasma display panel is disclosed. The method may include erasing a condition of a wall charge formed by a previous sustain discharge, and establishing a wall charge so as to stably perform a next address discharge to perform a reset period; selecting cells that are turned on and those that are not turned on, and accumulating the wall charges on the turned-on cells (addressed cells) to perform an address period; and executing a discharge for displaying images to the addressed cells to perform a sustain period, so that an applied voltage allows the voltage level applied to the sustain electrode to fall along a predetermined gradient, or ramp waveform, or stepwise waveform, during the address period.

### CROSS REFERENCE TO RELATED APPLICATION

This application claims priority of Korean Patent Application No. 2003-59693 filed on Aug. 27, 2003 in the Korean Intellectual Property Office, which is herein incorporated by reference.

### BACKGROUND OF THE INVENTION

1. Field of the Invention

The present invention relates to plasma display panels generally. In particular, the present invention relates to a driving method of a sustain electrode during an address period of a plasma display panel.

2. Description of the Related Art

Flat display devices such as liquid crystal displays (LCDs), field emission displays (FEDs), and PDPs have been actively developed in recent years. Of the above flat display devices, PDPs have higher brightness and emission efficiency, and wider visual fields than other flat display devices. Therefore, PDPs have begun to replace cathode ray tubes (CRTs) in the field of large-sized display devices of over 40 inches.

A plasma display panel (PDP) is a flat display for displaying characters or images using plasma generated by gas discharge, and several tens to several millions of pixels are arranged in a matrix format on the PDP according to the PDP size. The PDP is classified as a DC PDP or an AC PDP depending on waveforms of applied driving voltages and configurations of discharge cells.

Electrodes of a DC PDP are directly exposed to a discharge space, and current directly flows through a discharge space when a voltage is applied. However, a weakness of the DC PDP is that a resistor is needed to restrict such current. In an AC PDP on the other hand, electrodes are covered with a dielectric layer to naturally form a capacitance component which restricts a current. Consequently, electrons of an AC PDP are protected from ion impact at discharge. As a result, the AC PDP has a longer life than the DC PDP.

FIG. 1 is a partial perspective view of a panel of an AC plasma display panel. As shown in FIG. 1, parallel pairs of a scan electrode 4 and a sustain electrode 5 are arranged on a substrate 1, and are covered with a dielectric layer 2 and a protective layer 3. A plurality of address electrodes 8, which are covered with an insulating layer 7, are arranged on a substrate 6.

Barrier ribs 9 are formed in parallel with the address electrodes 8 on the insulating layer 7, which 10 is interposed between the address electrodes 8. A fluorescent material 10 is formed on the surface of the insulating layer 7 and on both sides of the barrier ribs 9. The substrates 1 and 6 are arranged in a face-to-face relationship with a discharge space 11 formed therebetween, so that the scan electrodes 4 and the sustain electrodes 5 lie in a direction perpendicular to the address electrodes 8. Discharge spaces at intersections between the address electrodes 8 and the pairs of is scan electrode 4 and sustain electrode 5 form discharge cells 12.

FIG. 2 shows a three electrode surface discharge structure of a plasma display panel. As shown, an address electrode is arranged in a direction perpendicular to a scanning electrode and a sustain electrode which are arranged in a face-to-face relationship, in a discharge space formed by a partition.

The partition forms a discharge space, and it blocks or reduces light generated at discharge to prevent an erroneous action (cross talk) of adjacent pixels. The above unit structures form several matrix formats on one substrate, and several million pixels are arranged in the matrix format on a PDP. A pixel is constructed by applying fluorescent materials on the unit constructer, and a plasma display panel is composed of the pixels. In accordance with recent common plasma display panels, a discharge is made in each pixel to generate ultraviolet rays which excite fluorescent materials applied to inner walls of the pixels to achieve an object color.

A plasma display panel needs to embody a medium gray scale to achieve performance as a color display. Recently, a method for embodying a medium gray scale has been used in which time division is used to control plural subfields separated from one TV field.

FIG. 3 shows a common method for embodying a medium gray scale of an AC plasma display panel. Illustratively, one method for embodying a 6-bit gray scale, includes dividing one TV field into 6 subfields SF1, SF2, SF3, SF4, SF5, and SF6. Each subfield is constructed to be divided into an address period and a display discharge sustain period. For example, SF1 is divided into address field Al and display discharge sustain period 1T. As shown, the display discharge sustain period may double in length for each successive subfield. Thus, SF6 has an address period A6 and a display discharge sustain period to 32T.

FIG. 4 shows various types of signal waveforms that may be applied to each electrode during one subfield period. Here, the X electrode is a sustain electrode, the Y electrode is a scanning electrode, and the A electrode is a data electrode. As shown, the wave forms applied to each electrode may differ from each other.

As shown in FIG. 4, the potential level of the X electrode makes electrons transfer to the X electrode after an address discharge occurs between the A electrode and the Y electrode.

When the potential of the X electrode is low, a sustain discharge voltage rises since electrons produced from an address operation are not sufficiently accumulated to the X electrode.

On the other hand, if the potential of the X electrode is high, more electrons generated from the address operation are transferred to the X electrode. As a result, a discharge started after completion of an address period is easier if begun during a sustain discharge period.

However, excessive electrons are sometimes transferred to the X electrode when this occurs a self erase discharge is initiated that somewhat inhibits the sustain discharge. Because the potential of the X electrode during the address period intimately influences operation of the panel, the potential of the X electrode should be controlled to have an appropriate potential.

As shown in FIG. 4, the whole address period is commonly maintained at a constant potential level.

As one example, in an SD graded plasma display panel, a Tscan (Scan Pulse Width) time measured from an address operation of the first line to an address operation of the 480^{th} line takes approximately 479*Tscan. In a case where Tscan is 1.5 microseconds, about 720 microseconds is taken from an address of the first line to an address of the last line. After the above period is passed, the wall charge and the space charge after the address operation of each scanning electrode are largely changed. That is, during the address operation of the last line, a portion of each of the space charge and the wall charge are reduced at the line previously addressed. Thus, after the address operation finishes, the condition of each scanning electrode is not the same.

Electrons are generated from a scanning electrode during the address operation. Some of these electrons are transferred to the address electrode and some are transferred to the X electrode. The amount of electrons transferred to the X electrode is proportional to a potential of the X electrode. That is, in the case the potential of the X electrode is high, a large amount of electrons are transferred to the X electrode, to lower a sustain discharge voltage at the operation of the sustain discharge following an address period. However, as mentioned above, when the address operation of all the scanning electrodes is finished, the state of the wall charge and space charge is not the same between the first line and the last line. Thus, when the sustain discharge voltage is applied, some cells discharge normally, some cells discharge weakly, and some cells discharge excessively to cause self erase. A solution is needed that provides a substantially uniform discharge and which reduces or prevents self-erase.

### SUMMARY OF THE INVENTION

In the present invention, there is provided a method for driving a plasma display panel while constantly maintaining uniformity of a wall charge of a scanning line addressed first and a scanning line addressed last. To achieve this, one embodiment of the present invention provides a plasma display panel that displays data through a reset period, an address period, and a sustain period after receiving external video data.

The PDP includes a plurality of address electrodes and a plurality of paired scanning electrodes and sustain electrodes crossed with the address electrode. After receiving the video data, a controller outputs a scanning electrode driving signal, a sustain electrode driving signal, and an address electrode driving signal. In particular, the controller may output the sustain driving signal to allow a potential level of the sustain electrode to fall in accordance with a predetermined rule during the address period. Meanwhile, an address data driver applies a voltage corresponding to address electrode driving signals to the address electrode. A sustain electrode driver applies a voltage corresponding to sustain electrode driving signals to the sustain electrode. And, a scanning electrode driver applies a voltage corresponding to scanning electrode driving signals to the scanning electrode.

Further, a plasma display panel according to another aspect of the present invention is a plasma display panel in which a plurality of subfields are generated from input video signals, each subfield being separately driven in a reset period, an address period, and a sustain period divided according to sustain information. In this embodiment, the plasma display panel includes at least: a first electrode and a second electrode; a first space defined by the first electrode and the second electrode; and a driving circuit transferring a driving signal to the first electrode and the second electrode during each address period. The driving circuit is configured to cause a potential of voltage applied to the first electrode fall in accordance with a predetermined rule during the address period.

In another embodiment, a driving method of a plasma display panel erases a condition of a wall charge formed by a previous sustain discharge, and establishes a wall charge so as to stably perform a next address discharge to perform a reset period. The method may also select cells that are turned on and those that are not turned on from the panel, and accumulate the wall charges on the turned-on cells (addressed cells) during an address period. Additionally, the method may execute a discharge for displaying images to the addressed cells to perform a sustain period, apply a voltage so as to allow the voltage level applied to the first electrode to fall in accordance with a predetermined rule during the address period.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a partial perspective view of a panel of an AC plasma display panel (PDP).

FIG. 2 illustrates an arrangement of electrodes in the PDP of FIG. 1.

FIG. 3 shows a waveform of a driving signal applied to each electrode of the PDP of FIG. 1.

FIG. 4 shows a driving waveform of an existing PDP.

FIG. 5 shows a construction diagram of a PDP according to the first exemplary embodiment.

FIG. 6 shows a driving waveform of a PDP according to the first exemplary embodiment.

FIG. 7 shows a driving waveform of a PDP according to the second exemplary embodiment.

FIG. 8 shows a driving waveform of a PDP according to the third exemplary embodiment.

FIG. 9 shows a brief circuit diagram of a driving circuit according to the first exemplary embodiment.

FIG. 10 shows a waveform of a control signal applied to each transistor of a driving circuit according to the first exemplary embodiment.

FIG. 11 shows a brief circuit diagram of a driving circuit according to the second exemplary embodiment.

FIG. 12 shows a waveform of a control signal applied to each transistor of a driving circuit according to the second exemplary embodiment.

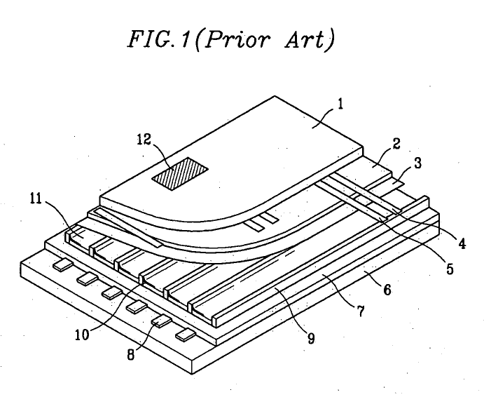

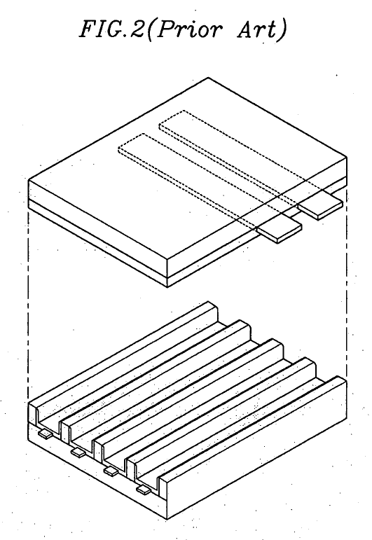

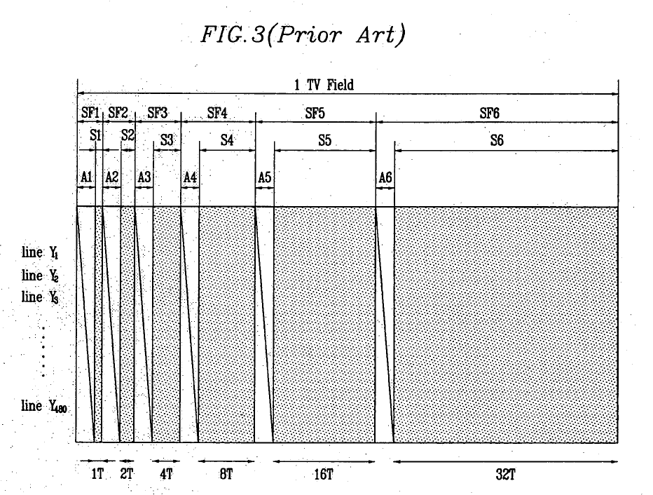

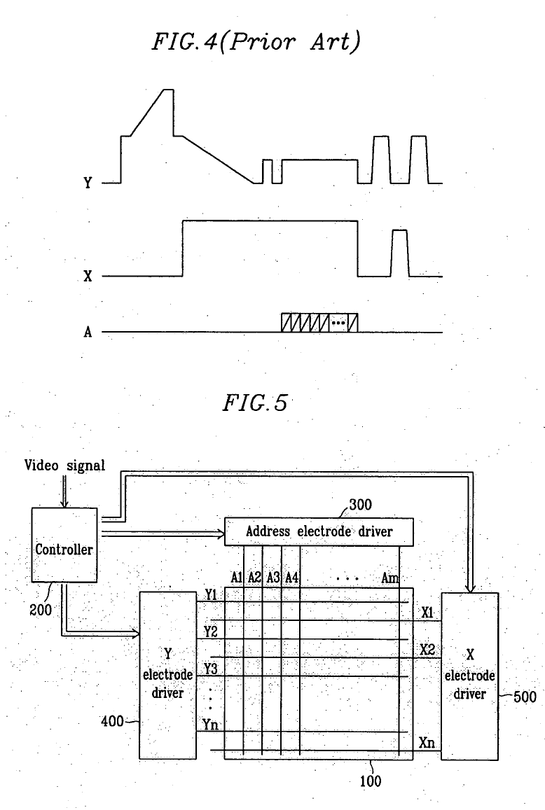

### DETAILED DESCRIPTION OF THE PREFERRED EMBODIMENTS

In the drawings, parts not related to the explanation are not shown, for clearer explanation. Identical drawing marks are used for similar parts in the specification. When it is explained that some part is connected to another part, it does not necessarily mean that both parts are directly connected, but also that some element can be electronically inserted between both parts.

Various embodiments of a plasma display panel (PDP), a driving device of the PDP, and a driving method thereof are now explained with reference to the drawings.

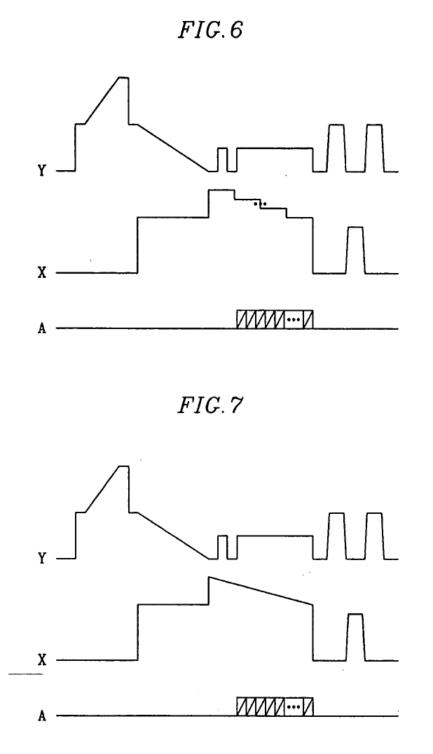

FIG. 5 shows a construction diagram of a PDP according to the first exemplary embodiment. As shown, a plasma display panel according to a first exemplary embodiment includes a plasma panel 100, a controller 200, an address electrode driver 300, a scanning electrode driver (hereinafter ‘Y electrode driver’) 400, and an sustain electrode driver (hereinafter ‘X electrode driver’) 500.

The plasma panel 100 includes a plurality of address electrodes A₁ to Aₘ arranged in the column direction, a plurality of sustain electrodes (referred to as X electrodes hereinafter) X₁ to Xₙ arranged in the row direction, and a plurality of scan electrodes (referred to as Y electrodes hereinafter) Y₁ to Yₙ arranged in the row direction. The X electrodes X₁ to Xₙ are formed corresponding to the respective Y electrodes Y₁ to Yₙ, and their ends are connected in common. The plasma panel 100 includes a glass substrate (not shown) on which the X and Y electrodes X₁ to Xₙ and Y₁ to Yₙ are arranged, and a glass substrate (not shown) on which the address electrodes A₁ to Aₘ are arranged. The two glass substrates face each other with a discharge space therebetween so that the Y electrodes Y₁ to Yₙ may cross the address electrodes A₁ to Aₘ and the X electrodes X₁ to Xₙ may cross the address electrodes A₁ to Aₘ. In this instance, discharge spaces defined by the crossing of the address electrodes A₁ to Aₘ and the X and Y electrodes X₁ to Xₙ and Y₁ to Yₙ form discharge cells.

The controller 200 externally receives video signals, and outputs address driving signals, X electrode driving signals, and Y electrode driving signals. Also, the controller 200 divides a single frame into a plurality of subfields and drives them, such that each subfield includes a reset period, an address period, and a sustain period with respect to temporal operation variations. In a particular embodiment, the controller outputs the X electrode driving signal in a manner that allows a voltage level applied to the X electrode to fall along a predetermined gradient, or in accordance with a predetermined rule, during the address period.

The address driver 300 receives address electrode driving signals from the controller 200, and applies video data signals for selecting desired discharge cells to each address electrodes A₁ to Aₘ.

The X electrode driver 500 receives X electrode driving signals from the controller 200, and applies driving voltages to the X electrodes X₁ to Xₙ to allow the driving voltage to fall along the predetermined gradient, or in accordance with a predetermined rule, during the address period.

The Y electrode driver 400 receives Y electrode driving signals from the controller 200, and applies driving voltages to the Y electrodes Y₁ to Yₙ.

The action of a plasma display device having the above constructions according to the exemplary embodiment is explained in detail hereinafter.

In one embodiment, a controller 200 externally receives video signals, corrects gamma values to satisfy properties of plasma display panels, and generates N subfields from the corrected video signals. The controller 200 then outputs X electrode driving signals, Y electrode driving signals, and address electrode driving signals for each subfield.

Then, an address driver 300 receives address electrode driving signals and applies video data signals to each address electrode A1-Am to select discharge cells for display.

Further, an X electrode driver 500 receives X electrode driving signals and applies driving voltages to X electrodes X1-Xn, and a Y electrode driver 400 receives Y electrode driving signals and applies driving voltages to Y electrodes Y1-Yn.

When the controller 200 generates X electrode driving signals, the controller 200 outputs X electrode driving signals to allow a potential level applied to the X electrodes to fall along a predetermined gradient, or in accordance with a predetermined rule. The X electrode driver applies driving voltages to the X electrodes to allow a potential level to fall along the predetermined gradient, or in accordance with a predetermined rule, according to the X electrode driving signals.

In the above process, the amounts of electrons accumulated on the X electrodes during the address period are differently controlled at respective scanning lines, and the uniformity of electric charges of all scanning lines is increased when the address period is finished. As a result, the margin of sustain discharge voltages in the panel is broadened, and low discharge and excessive discharge are reduced.

FIGS. 6, 7, and 8 show examples of voltage waveforms applied to X electrodes in the above process.

Referring to FIG. 6, waveforms for correcting non-uniformity among cells at the X electrode are illustrated according to the first exemplary embodiment. As shown, multiple potentials (e.g. “N” potentials) of the X electrode are prepared instead of a convential single potential. In one embodiment, the potential applied is at a high level during an early stage of the address period, and is low level near the end of the address period.

In this manner, the potential level of the X electrode can be determined to adequately assure an operation margin of the panel since restrictions of hardware construction are minimized.

As the above waveforms are applied, electrons generated during the address period accumulate on the X electrode at a much earlier stage of the address period than the conventional PDPs because the potential of the X electrode is high. When the address operation nears the end of the address period, the amount of electrons accumulated on the X electrode is reduced because the potential of the X electrode is low. However, since a reduction of space charge and wall charge is low, the amount of electrons accumulated on the X electrode is maintained at a uniform condition.

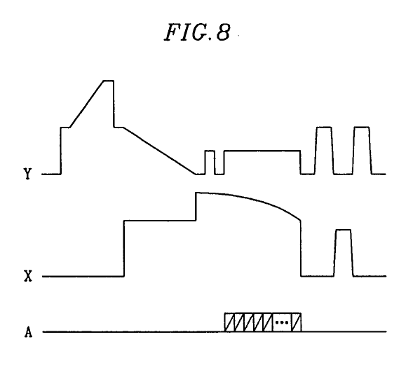

FIG. 7 shows a voltage waveform of a second exemplary embodiment having substantially the same effect as the first voltage waveform represented in FIG. 6.

As shown, the potential level of the X electrode is designed to be reduced at a constant rate from start to end of the address period via to a ramp waveform. In one embodiment, high X potentials are applied to cells addressed first, and more electrons are accumulated thereto. Relatively low X potentials are applied to cells addressed later, and the amount of electrons accumulated thereto is low. However, considering the reduced space charge and wall charge, the total amount of electrons accumulated on the X electrode is maintained at a substantially uniform condition.

FIG. 8 shows a voltage waveform of the third exemplary embodiment. As shown, a gradually lowered X potential during the address period is the same as with the previous two exemplary embodiments, except the X potentials fall according to an RC waveform. As with the prior embodiments, hardware may be easily constructed for the embodiment.

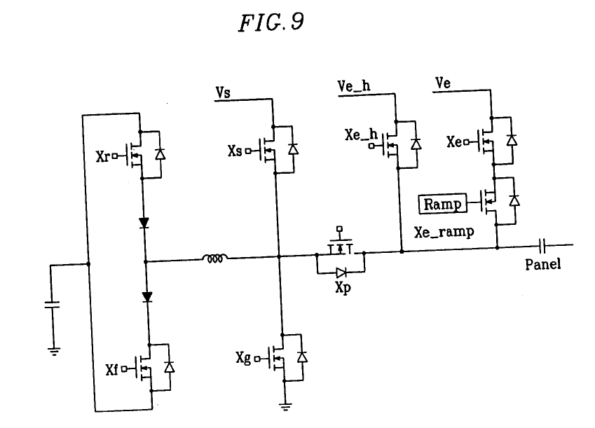

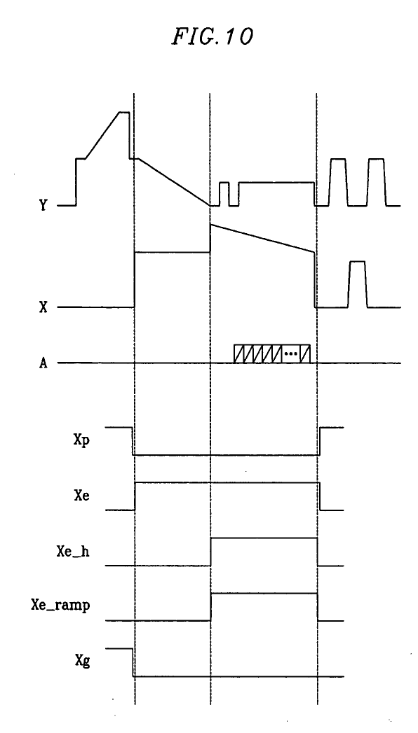

As such, the exemplary embodiments allow the voltage level applied to the X electrode to fall along a predetermined gradient during the address period to achieve uniformity of wall charges. To accomplish this, a driving circuit for performing application of voltage may be established at the X electrode driver 500. Hereinafter, the above driving circuit is explained while referring to FIGS. 9, 10, 11, and 12.

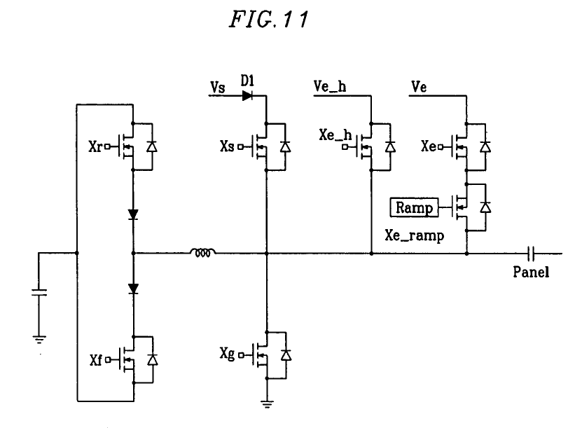

A driving circuit according to the first exemplary embodiment is explained in detail while referring to FIGS. 9 and 11. Among other types of waveforms applied to the sustain electrode, it may also generate a voltage waveform according to the second exemplary embodiment.

FIG. 9 shows a brief circuit of a driving circuit according to the first embodiment.

As shown in FIG. 9, a driving circuit may include transistors (Xs, Xg, Xe_h, Xp, Xe_ramp). The action of the driving circuit having the above construction according to the first embodiment is explained while referring to FIG. 10, as follows.

FIG. 10 shows a waveform of a control signal applied to respective transistors of the driving circuit according to the first exemplary embodiment. First, control signals applied to N-type transistors Xp, Xg are at a high state during the reset period. So that a voltage applied to a sustain electrode of the panel after the N-type transistors Xp, Xg are turned on is at a ground level.

Then, when the address period begins, only control signals applied to the transistor Xe are a high state. Thus transistor Xe is turned on, and the voltage level applied to the sustain electrode is Ve.

When control signals applied to transistors Xe_h, Xe_ramp become a high state, and transistors Xe_h, Xe_ramp are turned on, the voltage applied to the sustain electrode gradually decreases from Ve+Ve_h level to Ve level. Such a reduction of voltage results from properties of the ramp voltage.

Voltages applied to the sustain electrode during the address period can be embodied with the above process.

A driving circuit according to the second exemplary embodiment is explained as follows, and it embodies the waveform applied to the sustain electrode.

FIG. 11 shows a brief circuit of a driving circuit according to the second exemplary embodiment. The driving circuit according to the first embodiment includes transistors Xs, Xg, Xe_h, Xe_ramp. But, in the driving circuit of the second exemplary embodiment, a transistor Xp of the first exemplary embodiment is omitted and a diode D1 is added.

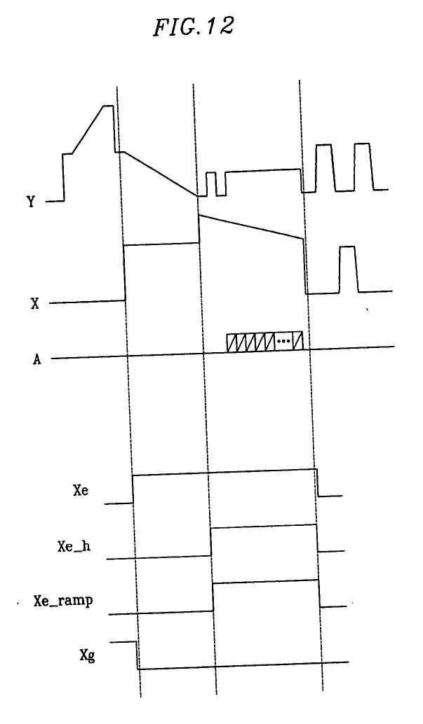

The action of the driving circuit having the above construction according to the second embodiment is explained while referring to FIG. 12 as follows. FIG. 12 shows a waveform of a control signal applied to respective transistors of the driving circuit according to the second exemplary embodiment. Because the control signals applied to the N-type transistor Xg are a high state during the reset period, a voltage applied to a sustain electrode of the panel after the N-type transistor Xg is turned on is at a ground level.

Then, when the address period begins, only the control signals applied to the transistor Xe are in a high state. Thus, the transistor Xe turns on and applies a voltage level Ve to the sustain electrode. Then, when control signals applied to transistors Xe_h, Xe_ramp become a high state, and transistors Xe_h, Xe_ramp are turned on, the voltage applied to the sustain electrode gradually decreases from the Ve+Ve_h level to the Ve level. Such a reduction of voltage results from properties of the ramp voltage.

Voltages applied to the sustain electrode during the address period can be embodied with the above process. The above driving circuits can be embodied by various methods, can be modified if necessary, and can embody various waveforms.

According to the exemplary embodiments described above, the amount of electrons accumulated on X electrodes is controlled differently at respective scanning lines, so that uniformity of electric charges is high when the address period finishes. As a result, the margin of sustain discharge voltages in the panel is broadened, to reduce or eliminate the low discharges and excessive discharges formerly associated with conventional PDPs.

Further, the effect of the present invention can be increased in proportion to the number of scanning lines and size of cells. That is, the present invention may embody a high definition PDP. As used herein, the phrase “fall along a predetermined gradient” means that the potential level of an X electrode (e.g. “first electrode” or “sustain electrode”) is designed to be reduced at a constant or non-constant rate from start to end of an address period. Illustratively, but not limitingly, this may be accomplished using the various wave forms shown in FIGS. 6, 7, and 8

While the claimed invention has been described in connection with what is presently considered to be the most practical and preferred embodiment, it is to be understood that the invention is not limited to the embodiments disclosed, but, is intended to cover various modifications and equivalent arrangements included within the spirit and scope of the appended claims.

1. A plasma display panel, receiving external video data and displaying data through a reset period, an address period, and a sustain period, the plasma display panel comprising:
a plasma panel comprising a plurality of address electrodes and a plurality of paired scanning electrodes and sustain electrodes crossed with the address electrodes;
a controller for receiving the video data, and outputting a scanning electrode driving signal, a sustain electrode driving signal, and an address electrode driving signal, the controller outputting the sustain driving signal to apply a potential level of the sustain electrode along a predetermined gradient during the address period;
an address data driver for applying a voltage corresponding to address electrode driving signals to the address electrode;
a sustain electrode driver for applying a voltage corresponding to sustain electrode driving signals to the sustain electrode; and
a scanning electrode driver for applying a voltage corresponding to scanning electrode driving signals to the scanning electrode.

2. The plasma display panel of claim 1, wherein the controller outputs the sustain electrode driving signal to allow the potential level of the sustain electrode to fall along the predetermined gradient during the address period.

3. The plasma display panel of claim 1, wherein the controller outputs the sustain electrode driving signal to allow the potential level of the sustain electrode to fall stepwise during the address period.

4. The plasma display panel of claim 1, wherein the controller outputs the sustain electrode driving signal to allow the potential level of the sustain electrode to fall along an RC waveform during the address period.

5. A plasma display panel, wherein a plurality of subfields are generated from input video signals, each subfield being separately driven in a reset period, an address period, and a sustain period according to sustain information, comprising:
a first electrode and a second electrode;
a first space defined by the first electrode and the second electrode; and
a driving circuit for transferring a driving signal to the first electrode and the second electrode during each address period,
wherein the driving circuit allows a potential of a voltage applied to the first electrode to fall along a predetermined gradient during the address period.

6. The plasma display panel of claim 5, wherein the driving circuit allows the potential of the voltage applied to the first electrode to fall along the predetermined gradient during the address period.

7. The plasma display panel of claim 6, wherein the first electrode is a sustain electrode and the second electrode is a scanning electrode.

8. The plasma display panel of claim 5, wherein the driving circuit allows the potential level of the sustain electrode to fall stepwise during the address period.

9. The plasma display panel of claim 5, wherein the driving circuit allows the potential of the voltage applied to the first electrode to fall along an RC waveform during the address period.

10. A method for driving a plasma display panel, comprising:
erasing wall charges formed by a previous sustain discharge, and establishing wall charges so as to stably perform a next address discharge to thus perform a reset period;
selecting cells that are turned on and those that are not turned on from the panel, and accumulating wall charges on the turned-on cells (addressed cells) to thus perform an address period; and
executing a discharge for displaying images to addressed cells to thus perform a sustain period,
wherein a voltage is applied to a first electrode while allowing a level of the voltage to fall along a predetermined gradient during the address period.

11. The method of claim 10, wherein the voltage is applied to the first electrode while allowing a level of the voltage to fall along the predetermined gradient during the address period.

12. The method of claim 11, wherein the first electrode is a sustain electrode, and the predetermined gradient is a first order function.

13. The method of claim 10, wherein the voltage is applied to the sustain electrode while allowing a level of the voltage to fall stepwise during the address period.

14. The method of claim 10, wherein the voltage is applied to the sustain electrode while allowing a level of the voltage to fall along an RC waveform during the address period.
